(19) United States
(12) Patent Application Publication
(10) Pub. No.: US 2012/0316952 A1
(43) Pub. Date: Dec. 13, 2012

(54) STORYTELLING DELIVERY BASED ON REQUEST

(75) Inventors: Yanlin Huang, Beijing (CN); Bing Wu, Beijing (CN); Ting Xu, Beijing (CN); Ricky Sun, Beijing (CN)

(73) Assignee: MICROSOFT CORPORATION, Redmond, WA (US)

(21) Appl. No.: 13/159,403

(22) Filed: Jun. 13, 2011

(51) Int. Cl. G06Q 30/00

(52) U.S. Cl. 705/14.39

(57) ABSTRACT

A request may be received for information associated with at least one of a plurality of recorded audio stories that each include an audio recording of a human naturally telling a story. Transmission of a list of story attributes associated with the recorded audio story may be initiated. An indication of a story attribute selection associated with the list of story attributes may be received. A selection of one of the recorded audio stories may be initiated based on the indication of the story attribute selection associated with the list of story attributes. A sponsored item may be determined based on at least one of the request, the selected recorded audio story, or a current event. Transmission of the selected recorded audio story to a receiving device via a streaming transmission medium may be initiated. Transmission of the sponsored item to the receiving device may be initiated.

### BACKGROUND

Throughout human history, storytelling has been recognized as a vehicle for communicating factual histories as well as fictional depictions of historical events, fictional depictions of situations associated with ethical dilemmas, hazards, behavior, and their potential outcomes or solutions. For example, parents have read or told fairy tales to their children for many years as a parent-child sharing experience to aid in comforting the children as they prepare for nighttime sleep. In many instances, the children may read or tell stories to their parents, or to other children. These storytelling experiences may provide comfort or entertainment for both the children and the adults involved in the experiences. As another example, storytelling may be used to comfort children and/or adults and/or animals such as pets through stressful experiences such as thunderstorms or stressful world, community, or group events. As yet another example, campers may enjoy storytelling experiences as they are seated around a campfire at the end of their daily camping activities.

Recipients of storytelling may prefer to hear their stories told by specific storytellers, based on attributes such as voice quality, gender, and a perceived familiarity with, or animated interest in, the subject matter of various stories. The recipients may also prefer to hear a fairy tale or a story associated with a particular hobby such as a specific athletic activity or artistic activity, at different points in time.

### SUMMARY

According to one general aspect, a storytelling delivery engine may include a story database interface engine configured to obtain, via a storytelling delivery processor, story attribute information associated with a plurality of recorded audio stories that each include an audio recording of a human naturally telling a story. The storytelling delivery engine may also include an audio story request manager configured to receive a request associated with a user of an audio story delivery service. The storytelling delivery engine may also include an audio story selection engine configured to access at least one user profile associated with the request, obtain a selection of one of the recorded audio stories based on information included in the user profile and the request, access the story attribute information that is associated with the selected one of the recorded audio stories via the story database interface engine, and obtain at least one sponsored item based on at least one of the request, the user profile, the story attribute information associated with the selected one of the recorded audio stories, or a current event. The storytelling delivery engine may also include an audio story delivery manager configured to initiate transmission of a recorded audio story associated with the selection to a receiving device via a streaming transmission medium and initiate transmission of the sponsored item to the receiving device.

According to another aspect, a computer program product tangibly embodied on a computer-readable medium may include executable code that, when executed, is configured to cause at least one data processing apparatus to receive a request for information associated with at least one of a plurality of recorded audio stories that each include an audio recording of a human naturally telling a story, and initiate transmission, via a storytelling delivery processor, of a list of story attributes associated with the at least one of the plurality of recorded audio stories. Further, the at least one data processing apparatus may receive an indication of a story attribute selection associated with the list of story attributes, initiate a selection of one of the recorded audio stories based on the indication of the story attribute selection associated with the list of story attributes, and determine at least one sponsored item based on at least one of the request, the selected recorded audio story, or a current event. Further, the at least one data processing apparatus may initiate transmission of the selected recorded audio story to a receiving device via a streaming transmission medium and initiate transmission of the sponsored item to the receiving device.

According to another aspect, a computer program product tangibly embodied on a computer-readable medium may include executable code that, when executed, is configured to cause at least one data processing apparatus to receive, via a user device processor, a user request for a streaming transmission of at least one of a plurality of recorded audio stories that each include an audio recording of a human naturally telling a story and send a device request that includes at least one device identification, a user identification associated with the user, and request information indicating the user request for the streaming transmission of the at least one recorded audio story, to a storytelling delivery service device. Further, the data processing apparatus may initiate a streaming audio input session associated with the requested streaming transmission of the at least one recorded audio story and initiate an output of a transmission of a sponsored item associated with the requested streaming transmission to a recipient of the streaming audio input session associated with the requested streaming transmission.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. The details of one or more implementations are set forth in the accompanying drawings and the description below. Other features will be apparent from the description and drawings, and from the claims.

### DRAWINGS

FIG. 1 is a block diagram of an example system for storytelling delivery based on request.

FIG. 2 is a block diagram of an example system for storytelling receipt based on request.

FIGS. 3a-3b are a flowchart illustrating example operations of the system of FIG. 1.

FIGS. 4a-4c are a flowchart illustrating example operations of the system of FIG. 1.

FIGS. 5a-5b are a flowchart illustrating example operations of the system of FIG. 2.

FIG. 6 depicts an example user view of a graphical display of an example selection display on a device.

FIG. 7 depicts an example user view of a graphical display of an example selection display on a device.

FIG. 8a depicts an example user view of a graphical display of an example selection display on a device.

FIG. 8b depicts an example user view of a graphical display of a sponsored item visual image display on a device.

FIG. 9 is a block diagram of an example system for storytelling delivery based on request.

### DETAILED DESCRIPTION

Storytelling has long been a popular pastime for many people, including parents spending time with their children at bedtime. The parents may be very tired at the end of their workday, and may fall asleep before their children as they attempt to finish telling a story selected by the children. Further, interruptions may disrupt the storytelling experience (e.g., a pet needs to be escorted outside, one of the children needs a drink). Parents and/or children may prefer audio storytelling over visually enhanced stories due to potential eye strain and a preference to encourage the listener to use their own mental imagery in lieu of predetermined imagery provided by an artistic rendering. Parents may also wish to avoid having their children watching a video device for extended periods of time at bedtime.

Potential storytellers may purchase books of stories such as fairy tales, or check books out from libraries, with advanced planning. Storytellers may also wish to avoid potential liability that may arise from copying works protected by copyright laws.

Example techniques discussed herein may provide services for storytelling delivery based on requests by users. Users may request various stories to be told via a streaming transmission medium, on demand, to be transmitted to a device associated with the user. For example, a parent may request that a particular story requested by his/her child be transmitted to a mobile device such as a smart phone or other mobile computing device, and an audio transmission of an audio recording of a storyteller telling the requested story may be streamed to the receiving device. Sponsored items of interest may also be transmitted to the device, in association with the story.

Users may generate albums, or collections of favorite stories, so that they may select from their favorites at times when they wish to receive the streaming audio of their story. A storytelling delivery service may also provide recommendations of stories for selection by the user. The recommendations may be based on general popularity of the stories or events occurring at times surrounding a particular user request. For example, stories related to baseball may be recommended during the World Series playoffs. The sponsored items of interest may also be selected based on similar criteria. For example, an advertisement for a particular brand of cereal that includes an image or brief audio clip associated with a baseball hero may be sent in association with a story related to baseball.

If desired, users may provide information regarding various attributes that may be used for a storytelling service to generate recommendations of various categories of stories. If desired, the users may also provide information regarding particular types of sponsored content they may prefer to receive or not receive. For example, a user may appreciate receiving advertising information informing him/her of various discounts for pizza that may be delivered to their home while they are listening to a story relating to football during football season. Such ads may, for example, be transmitted to be received by the user as a flash screen at the beginning of a story, or may be sent as an audio clip that may be heard at the beginning of the story, or at breaks during the story (e.g., when a pause in the story is requested). For example, a user may appreciate an opportunity to request that no sponsored item or story recommendations be sent that may be associated with the consumption of alcoholic beverages, or that may be associated with adult-oriented personal products. Further, a user may be provided with an opportunity to request that no information that may identify the user be stored in a database such as a user profile database, and/or that no information specifically associated with the user be shared with entities other than the storytelling service, and for no purposes other than for providing the recorded audio stories therein.

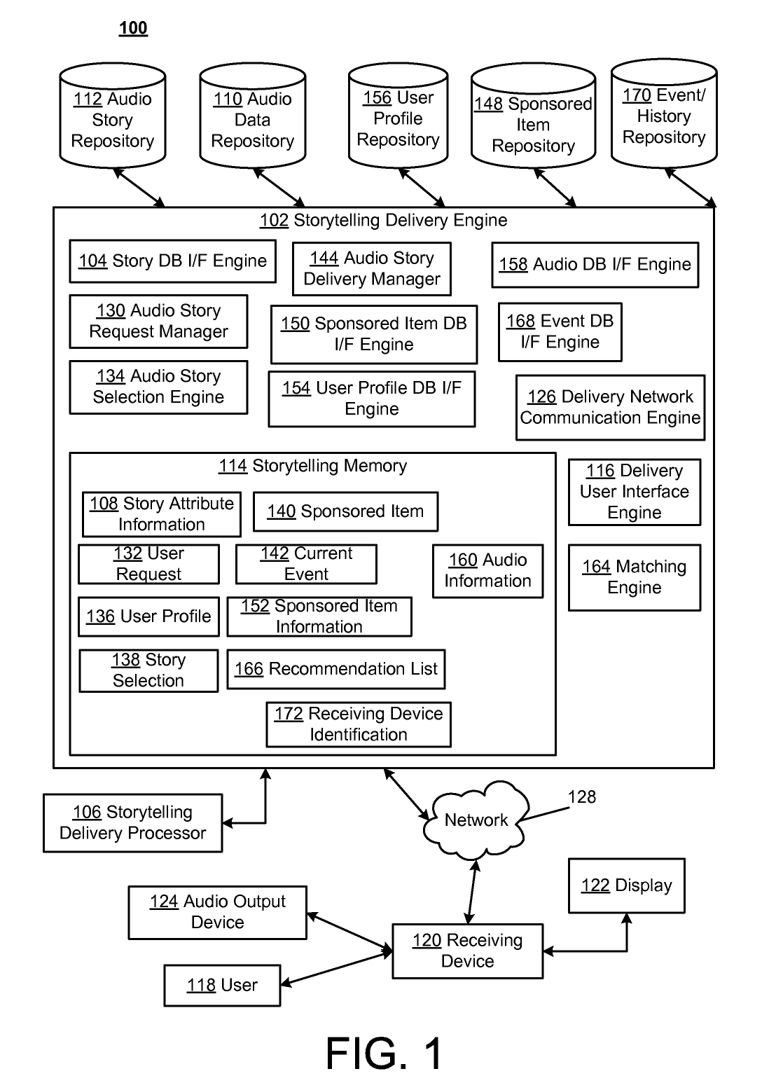

As further discussed herein, FIG. 1 is a block diagram of a system 100 for storytelling delivery based on request. As shown in FIG. 1, a system 100 may include a storytelling delivery engine 102 that includes a story database interface engine 104 that may be configured to obtain, via a storytelling delivery processor 106, story attribute information 108 associated with a plurality of recorded audio stories that each include an audio recording of a human naturally telling a story.

In this context, a “processor” may include a single processor or multiple processors configured to process instructions associated with a processing system. A processor may thus include multiple processors processing instructions in parallel and/or in a distributed manner. In this context, a human “naturally” telling a story may include a human naturally reading a story, a human naturally telling a story from memory, or a human naturally telling a story that is generated as the story is told. The audio recording of the human naturally telling a story may therefore include a recording of a human as a listener might experience if the storyteller were physically present with the listener.

According to an example embodiment, an audio data repository 110 may be configured to store the plurality of recorded audio stories that each include an audio recording of a human naturally telling a story. For example, the audio data repository 110 may include audio recordings of popular children's stories told by popular storytellers.

According to an example embodiment, an audio story repository 112 may be configured to store the story attribute information 108 associated with the plurality of recorded audio stories. For example, the story attribute information 108 may be persistently stored in the audio story repository 112, and may include at least one of a name of a story, at least one category associated with the story (e.g., fairy tale, sport related, religious, bedtime, campfire), at least one topic associated with the story (e.g., siblings, parents, pets, bicycles, meals, homework, responsibilities), a demographic indicator, a popularity ranking, an indication of a time of day associated with the story content, a time of year associated with the story content, or a geographic location associated with the story content. For example, the audio story repository 112 may be configured to include at least one database (e.g., a relational database). According to an example embodiment, the story database interface engine 104 may obtain the story attribute information 108 from the audio story repository 112. One skilled in the art of data processing will appreciate that there are many techniques for storing repository information discussed herein (e.g., the story attribute information 108), such as various types of database configurations (e.g., SQL servers) and non-database configurations.

According to an example embodiment, the storytelling delivery engine 102 may include a storytelling memory 114 that may be configured to store the story attribute information 108 that is obtained from the audio story repository 112. In this context, a “memory” may include a single memory device or multiple memory devices configured to store data and/or instructions. Further, the storytelling memory 114 may span multiple distributed storage devices.

According to an example embodiment, a delivery user interface engine 116 may be configured to manage communications between a user 118 and the storytelling delivery engine 102. The user 118 may be associated with a receiving device 120 that may be associated with a display 122 and an audio output device 124. For example, the display 122 and the audio output device 124 may be configured to communicate with the receiving device 120, via internal device bus communications, or via at least one network connection.

According to an example embodiment, the storytelling delivery engine 102 may include a delivery network communication engine 126 that may be configured to manage network communication between the storytelling delivery engine 102 and other entities that may communicate with the storytelling delivery engine 102 via at least one network 128. For example, the at least one network 128 may include at least one of the Internet, at least one wireless network, or at least one wired network. For example, the at least one network 128 may include a cellular network, a radio network, or any type of network that may support streaming transmission of audio data and/or transmission of data for a visual display. For example, the delivery network communication engine 126 may manage network communications between the storytelling delivery engine 102 and the receiving device 120. For example, the delivery network communication engine 126 may manage network communication between the delivery user interface engine 116 and the receiving device 120.

In this context, “streaming transmission” may refer to a transmission that provides relatively unbroken continuity in the receipt of data. For example, ordering of data may be preserved from a transmitting device to a receiving device. For example, relatively little data may be dropped in a transmission, to ensure a perception of continuous reception at the receiving device.

According to an example embodiment, the user 118 may view visual data via the display device 122, and may listen to output of audio data that may be sent to the receiving device 120 via the audio output device 124. According to an example embodiment, the receiving device 120 may initiate receipt of the audio streaming data associated with the recorded audio story.

An audio story request manager 130 may be configured to receive a request 132 associated with a user of an audio story delivery service. For example, the audio story request manager 130 may receive the request 132 associated with the user 118. For example, the request 132 may be received by the delivery user interface engine 116 via the delivery network communication engine 126, and may be provided to the audio story request manager 130.

An audio story selection engine 134 may be configured to access at least one user profile 136 associated with the request 132, obtain a selection 138 of one of the recorded audio stories based on information included in the user profile 136 and the request 132, access the story attribute information 108 that is associated with the selected one of the recorded audio stories 138 via the story database interface engine 104, and obtain at least one sponsored item 140 based on at least one of the request 132, the user profile 136, the story attribute information 108 associated with the selected one 138 of the recorded audio stories, or a current event 142. For example, the audio story selection engine 134 may access a user profile 136 associated with the user 118, based on information associated with the request 132. For example, if the user 118 is a one-time user of a storytelling delivery service, then the user profile 136 may include information such as an identification of the receiving device 120 for setting up a session for streaming transmission of a recorded audio story. According to an example embodiment, for a one-time user, the user profile 136 may not be persistently stored in association with the storytelling delivery engine 102 for future storytelling requests associated with the one-time user.

An audio story delivery manager 144 may be configured to initiate transmission of a recorded audio story associated with the selection 138 to a receiving device (e.g., the receiving device 120) via a streaming transmission medium and initiate transmission of the sponsored item 140 to the receiving device 120. For example, the audio story delivery manager 144 may initiate transmission of the recorded audio story associated with the selection 138 based on requesting a streaming transmission of the selected recorded audio story from the audio data repository 110 to the receiving device 120. For example, the audio story delivery manager 144 may initiate transmission of the sponsored item 140 based on requesting a transmission of the sponsored item 140 from a sponsored item repository 148 or from the storytelling memory 114 to the receiving device 120.

According to an example embodiment, a sponsored item database interface engine 150 may be configured to access sponsored item information 152, wherein the audio story selection engine 134 may be configured to obtain the at least one sponsored item 140 via the sponsored item database interface engine 150. According to an example embodiment, the sponsored item repository 148 may be configured to store the sponsored item information 152 associated with the sponsored item 140. According to an example embodiment, the storytelling memory 114 may be configured to store the sponsored item 140 and the sponsored item information 152 that may be obtained from the sponsored item repository 148.

For example, the sponsored item information 152 may include at least one of a name of a sponsored item (e.g., a name of a product, a name of an event, a name of a service), a category of a sponsored item (e.g., toy, game, food, automobile, sports, arts, music), a demographic associated with the sponsored item (e.g., young child, male age 10-12, female age 15-16), or an indicator indicating a preference of target recipients (e.g., recipients associated with explicit permission granted for receiving information regarding the sponsored item, adult males, adult females, young child).

According to an example embodiment, a user profile database interface engine 154 may be configured to access at least one user profile 136 associated with at least one user (e.g., the user 118) of the audio story delivery service, wherein the audio story selection engine 134 may be configured to access the at least one user profile 136 associated with the request 132 via the user profile database interface engine 154. According to an example embodiment, a user profile repository 156 may be configured to store the user profile 136 associated with at least one user 118 of the audio story delivery service. According to an example embodiment, the storytelling memory 114 may be configured to store the at least one user profile 136 that may be obtained from the user profile repository 156.

According to an example embodiment, at least one of the user profiles 136 may include historical information associated with a history of selections of the recorded audio stories associated with one of the users 118.

According to an example embodiment, at least one of the user profiles 136 may include user information received from one of the users 118 associated with the at least one of the user profiles 136, including at least one of an indicator associated with an age, an indicator associated with a preference of a category of stories, an indicator associated with a preference of a type of receiving device, an indicator associated with a preference of a natural language, an indicator associated with an album of favorite stories, an indicator of a user preference for at least one of the recorded audio stories, an indicator associated with a preference of a category of sponsored items, or an indication of a permission type associated with the at least one of the user profiles 136. For example, the user profile 136 may include an indicator of a list, or album, of user preferred stories, so that a display may be generated for the display device 122, or for audio output via the audio output device 124, indicating a listing of user-preferred stories from which the user 118 may select for transmission. For example, the user profile 136 may include an indicator of a user preference for a particular natural language associated with the telling of the story. For example, a parent may wish that one or more stories be transmitted in different natural languages, for an educational experience in teaching/learning different natural languages. For example, parents may tell their children stories in English, and may then request transmission of the story in a different language.

For example, the user profile 136 may include an indicator of a user preference for a particular story to be transmitted at a particular point in a transmission session. For example, the user profile 136 may include an indicator of a user preference to receive a story that includes an end-of-day prayer of thanksgiving at the beginning and/or end of the transmission session.

For example, the user profile 136 may include an indicator of a user preference for a particular category of sponsored items 140. For example, a parent may indicate a preference for only child-appropriate educational material as sponsored items 140. As another example, the user 118 may include a preference for information associated with discounts offered on delivery foods such as pizza or Asian take-out foods. As another example, the user 118 may include a preference for information associated with shopping categories that the user 118 may prefer (e.g., shopping for jewelry, clothing, automobiles, furniture). Thus, selections of sponsored items 140 for transmission to the user 118 may be associated with the preferred shopping categories.

For example, the user profile 136 may include an indicator of a user preference for having a streaming transmission of a story to commence at a regularly scheduled time, to a particular receiving device 120. For example, the user 118 may include a preference for a story to be transmitted to a receiving device 120 that includes an audio output device 124 (e.g., a speaker device) located in a bedroom, so that a parent may expect that a story may be transmitted to a child at particular, regularly scheduled times. Thus, the parent may understand that their children may receive storytelling experiences even when the parent may be otherwise occupied (e.g., already asleep) at scheduled bedtimes for the children.

According to an example embodiment, albums or recommended listings of stories may also be provided to the user 118 based on preferences associated with entities other than the specific user 118. For example, albums or recommended listings of stories may be generated based on histories of requests and transmissions by the storytelling delivery engine to groups of users associated with attributes that may also be associated with the specific user 118, or based on popularity generally. According to an example embodiment, the user request 132 may include a request to shuffle a list such as album listing. For example, the audio story selection engine 134 may be configured to shuffle or rearrange lists of story attributes associated with the recorded audio stories.

According to an example embodiment, an audio database interface engine 158 may be configured to access audio information 160 associated with the recorded audio stories, wherein the audio story delivery manager 144 may be configured to initiate transmission of the recorded audio story associated with the selection 138 to the receiving device 120 via the audio database interface engine 158. For example, the streaming transmission of the recorded audio story may be transmitted from a transmitting device associated with the storytelling delivery engine 102 or from one or more transmitting devices otherwise configured to transmit streaming audio data to receiving devices 120 on demand, via initiation by the audio story delivery manager 144.

According to an example embodiment, the user profile 136 may be associated with at least one of a registered subscriber user or a non-subscriber user. The user profile 136 associated with the non-subscriber user may include an indication of a user preference of permission denial of storage of the user profile associated with the non-subscriber user in the user profile repository 156 and/or permission denial of sharing of user attributes associated with the non-subscriber user. For example, the user 118 may agree to a subscription service associated with a storytelling delivery service, and may agree to provide user information, and may agree that the information may be persistently stored, for example, in the user profile repository 156. For example, the user 118 may also agree to a non-subscriber use of the storytelling delivery service (e.g., one-time use), and may provide a denial of permission to share specific user attributes associated with the non-subscriber user with other entities. For example, the user 118 may prefer to deny permission to share an identity of the user 118 or the receiving device 120 with other entities.

According to an example embodiment, a sponsored item matching engine 162 may be configured to determine the sponsored item 140 based on matching characteristics associated with at least two of the user profile 136, the story attribute information 108 associated with the selected one of the recorded audio stories 138, and the current event 142. According to an example embodiment, the current event 142 may include a time of day, a local event, a national event, a global event, a weather event, a sporting event, a movie event, a product introduction event, a religious event, a historical event, a date, and/or an artistic event. For example, the sponsored item matching engine 164 may determine the sponsored item 140 as a discount offer for delivery pizza based on matching a user profile 136 indicator for a pizza discount offer preference, and a national event indicator indicating Super Bowl Sunday.

According to an example embodiment, the audio story request manager 130 may be configured to receive behavioral indicators associated with a behavior of the user 118 and initiate update of one of the user profiles 136 associated with the user 118 based on the received behavioral indicators, and the audio story selection engine 134 may be configured to obtain a recommendation list 166 of suggested ones of the plurality of recorded audio stories based on at least one of the request 132, the user profile 136, a location associated with the user 118, a location associated with the receiving device 120, a weather condition indicator, an indicator of a time of day, a date indicator, a history of selections associated with a plurality of other users, or current events indicators. According to an example embodiment, the audio story delivery manager 144 may be configured to initiate transmission of the recommendation list 166 to the receiving device 120. For example, a location of the receiving device 120 may be determined based on location information (e.g., Global Positioning System (GPS) coordinates, cell phone location information, network address information associated with a network connection for the receiving device 120, location provided by user) that may be included with the user request 132.

For example, behavioral indicators may include a history of sending requests for stories at particular times, a history of requesting particular stories or particular categories of stories, or a history of requesting particular sponsored items. For example, the audio story selection engine 134 may obtain the recommendation list 166 that may include stories associated with hurricanes (e.g., hurricane survival stories), based on a weather condition indicator indicating current hurricane conditions.

According to an example embodiment, the audio story delivery manager 144 may be configured to initiate transmission of the sponsored item 140 to the receiving device 120 based on at least one of initiating transmission of a recorded audio clip associated with the sponsored item 140 based on a streaming transmission via the streaming transmission medium to the receiving device 120, or initiating transmission of visual image data associated with the sponsored item 140 to the receiving device 120. For example, the sponsored item 140 may include an audio clip of a popular athlete expressing his/her preference for a particular product such as breakfast cereal, sports equipment, sports beverages, apparel, communication devices, or automobiles. For example, the sponsored item 140 may include a visual image item such as image data depicting a picture of the athlete along with a picture of the product.

According to an example embodiment, an event database interface engine 168 may be configured to obtain the events and histories from an event/history repository 170 that is configured to store information associated with events and histories such as histories of requested and transmitted items over time.

According to an example embodiment, the audio story delivery manager 144 may be configured to receive a receiving device identification 172 that includes information associated with a requested receiving device 120 for receiving transmissions of the recorded audio stories or the sponsored items 140. According to an example embodiment, the user request 132 may include a request for the recorded audio story to be transmitted to a receiving device 120 that may be different from a user device used to send the user request 132 to the storytelling delivery engine 102.

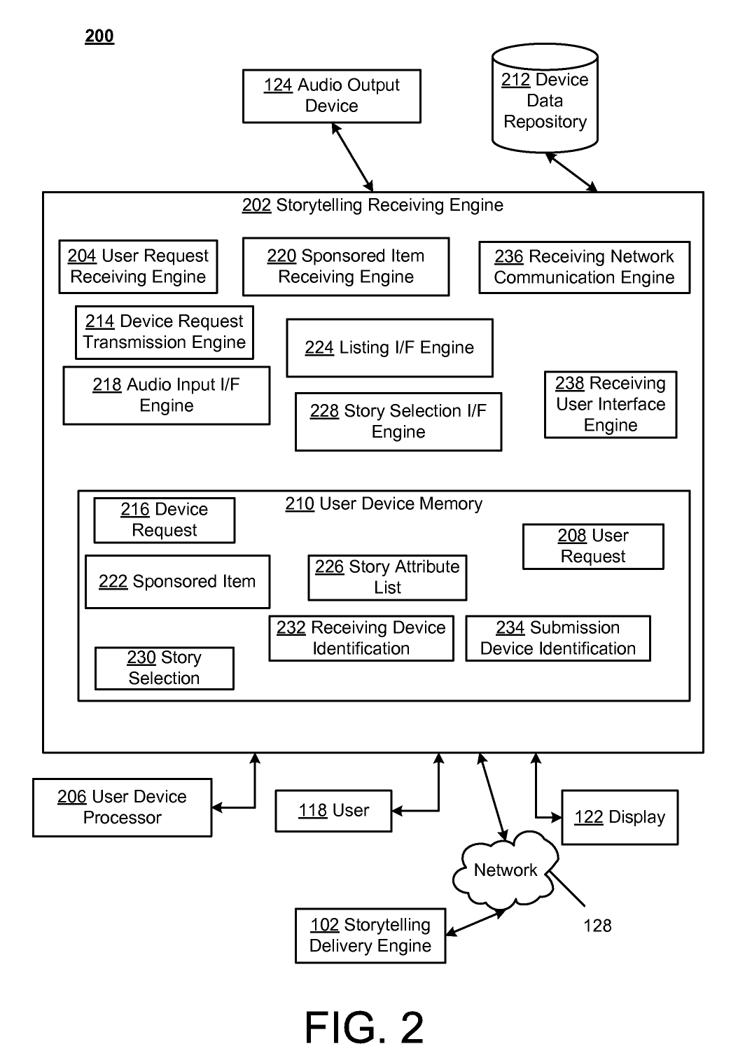

FIG. 2 is a block diagram of an example system for storytelling receipt based on request. For example, the system of FIG. 2 may include the receiving device 120 discussed above with regard to FIG. 1. As shown in FIG. 2, a system 200 may include a storytelling receiving engine 202 that may include a user request receiving engine 204 that may be configured to receive, via a user device processor 206, a user request 208 for a streaming transmission of at least one of a plurality of recorded audio stories that each include an audio recording of a human naturally telling a story. According to an example embodiment, a user device memory 210 may be configured to store the user request 208. According to an example embodiment, a device data repository 212 may be configured to persistently store data associated with the storytelling receiving engine 202. For example, the device data repository 212 may be located on a disk drive or other storage medium associated with the storytelling receiving engine 202.

A device request transmission engine 214 may be configured to send a device request 216 that includes at least one device identification, a user identification associated with the user 118, and request information indicating the user request 208 for the streaming transmission of the at least one recorded audio story, to a storytelling delivery service device. For example, the storytelling delivery service device may include the storytelling delivery engine 102.

An audio input interface engine 218 may be configured to initiate a streaming audio input session associated with the requested streaming transmission of the at least one recorded audio story. For example, the audio input interface engine 218 may initiate a streaming audio input session for the requested streaming transmission of the requested recorded audio story to the audio output device 124.

A sponsored item receiving engine 220 may be configured to initiate an output of a transmission of a sponsored item 222 associated with the requested streaming transmission to a recipient of the streaming audio input session associated with the requested streaming transmission. For example, the sponsored item receiving engine 220 may initiate the output of the transmission of the sponsored item 222 via the audio output device 124 (e.g., for an audio clip) or via the display 122 (e.g., for image data, as discussed above).

According to an example embodiment, a listing interface engine 224 may be configured to initiate a display of a list of story attributes 226 associated with the plurality of recorded audio stories on a display device 122 associated with the user 118. For example, a list of story titles may be displayed on the display device 122. According to an example embodiment, the list 226 may be provided as an audio output via the audio output device 124. For example, the list of story attributes 226 may be received from the storytelling delivery engine 102, or may be retrieved from the device data repository 212. For example, the story attribute list 226 may include the recommendation list 166 that may be received from the storytelling delivery engine 102, as discussed above. For example, the story attribute list 226 may include a list of favorite stories (e.g., an album listing).

According to an example embodiment, a story selection interface engine 228 may be configured to receive a story selection 230 that includes an indication of at least one of the story attributes, wherein the device request 216 may include a device indication of the story selection 230. For example, the user 118 may provide an input indicating one of the story attributes (e.g., a title of a story) via an input device associated with the storytelling receiving engine 202 (e.g., a keyboard, touchpad, touchscreen, mouse click, audio input device for receiving voice input), the input received by the story selection interface engine 228. For example, the device indication of the story selection 230 may then be included in the device request 216, for transmission to the storytelling delivery engine 102.

According to an example embodiment, the list of story attributes 226 associated with the plurality of recorded audio stories may include at least one of a list of story titles, a list of story categories, a list of listener age ranges, a list of story ratings ranges, a list of story authors, a list of storyteller names, or a list of storyteller attributes. According to an example embodiment, the device indication of the story selection 230 may include an indication of a story selection input received from the user 118, as discussed above.

According to an example embodiment, the at least one device identification may include a device identification 232 associated with a story receiving device and a device identification 234 associated with a request submission device. According to an example embodiment, the audio input interface engine 218 may be configured to initiate the streaming audio input session associated with the requested streaming transmission of the at least one recorded audio story based on initiating the streaming audio input session to the story receiving device. According to an example embodiment, the story receiving device may be different from the request submission device.

According to an example embodiment, a receiving user interface engine 236 may be configured to manage communications between the user 118 and the storytelling receiving engine 202. For example, the display 122 and the audio output device 124 may be configured to communicate with the storytelling receiving engine 202, via internal device bus communications, or via at least one network connection.

According to an example embodiment, the storytelling receiving engine 202 may include a receiving network communication engine 238 that may be configured to manage network communication between the storytelling receiving engine 202 and other entities that may communicate with the storytelling receiving engine 202 via at least one network 128. For example, the at least one network 128 may include at least one of the Internet, at least one wireless network, or at least one wired network. For example, the at least one network 128 may include a cellular network, a radio network, or any type of network that may support streaming transmission of audio data and/or transmission of data for a visual display. For example, the receiving network communication engine 236 may manage network communications between the storytelling receiving engine 202 and the storytelling delivery engine 102. For example, the receiving network communication engine 236 may manage network communication between the receiving user interface engine and the storytelling delivery engine 102.

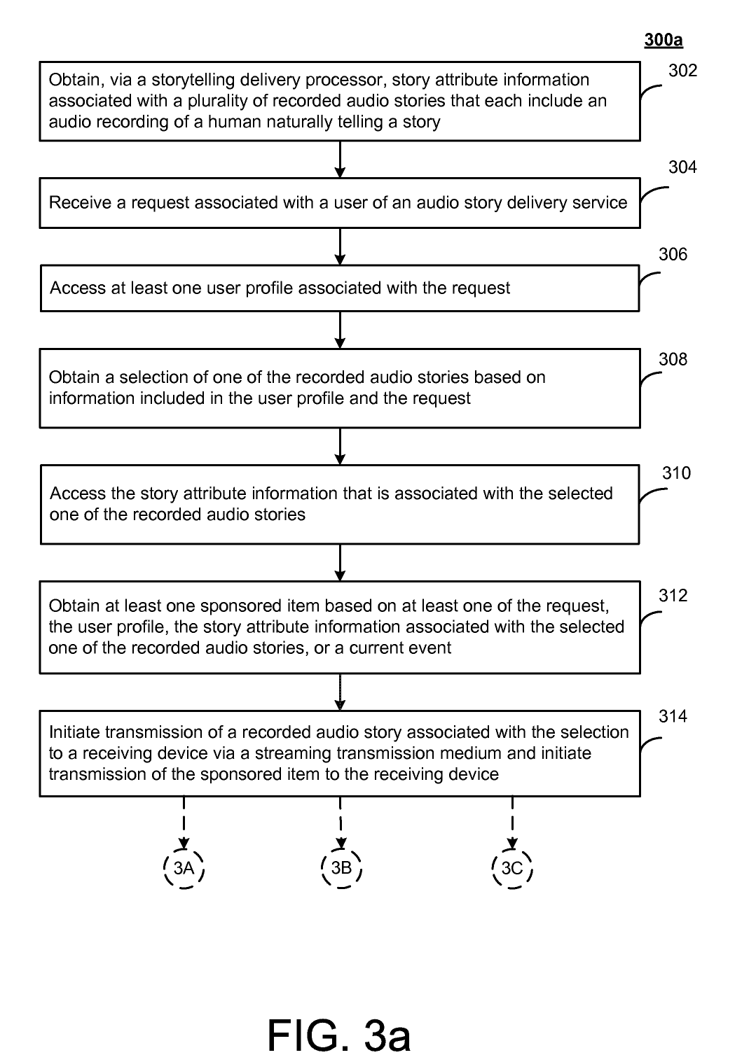

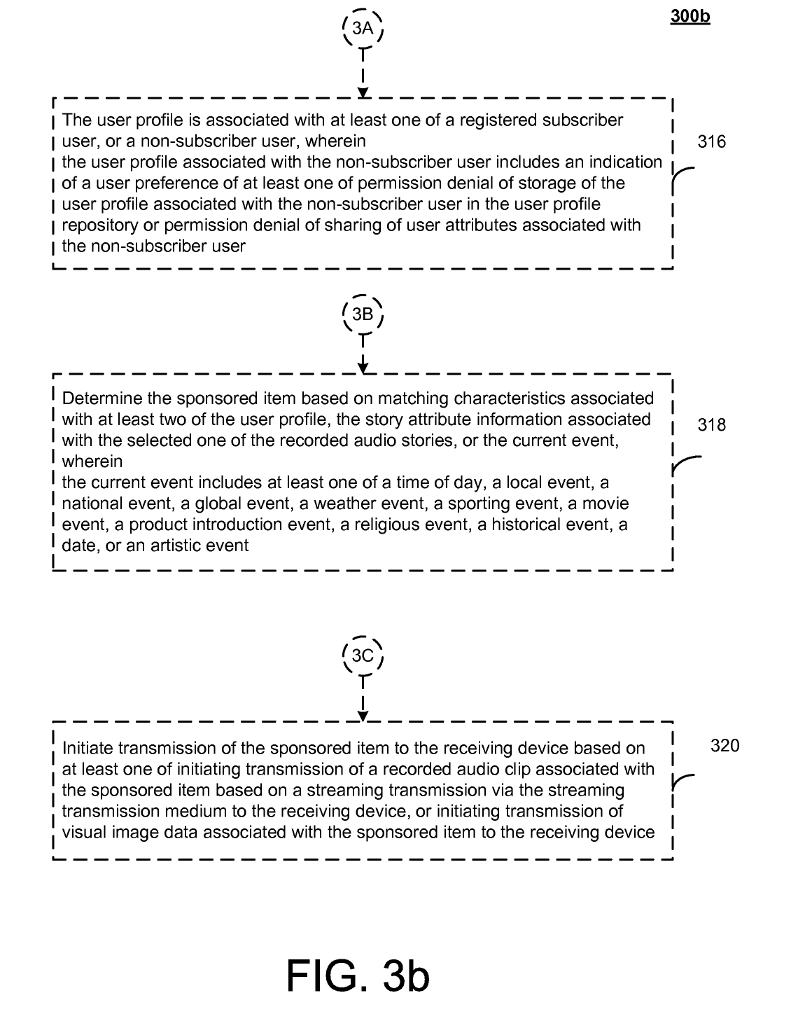

FIGS. 3a-3b are a flowchart illustrating example operations of the system of FIG. 1, according to example embodiments. In the example of FIG. 3a, story attribute information associated with a plurality of recorded audio stories that each include an audio recording of a human naturally telling a story may be obtained, via a storytelling delivery processor (302). For example, the story database interface engine 104 may obtain, via the storytelling delivery processor 106, story attribute information 108 associated with the plurality of recorded audio stories that each include an audio recording of a human naturally telling a story, as discussed above.

A request associated with a user of an audio story delivery service may be received (304). A selection of one of the recorded audio stories based on information included in the user profile and the request may be obtained (308).

The story attribute information that is associated with the selected one of the recorded audio stories may be accessed via the story database interface engine (310). At least one sponsored item may be obtained based on at least one of the request, the user profile, the story attribute information associated with the selected one of the recorded audio stories, or a current event (312).

For example, the audio story request manager 130 may receive the request 132 associated with a user of an audio story delivery service, as discussed above. At least one user profile associated with the request may be accessed (306). For example, the audio story selection engine 134 may access at least one user profile 136 associated with the request 132, obtain a selection 138 of one of the recorded audio stories based on information included in the user profile 136 and the request 132, access the story attribute information 108 that is associated with the selected one of the recorded audio stories 138 via the story database interface engine 104, and obtain at least one sponsored item 140 based on at least one of the request 132, the user profile 136, the story attribute information 108 associated with the selected one 138 of the recorded audio stories, or a current event 142, as discussed above.

Transmission of a recorded audio story associated with the selection to a receiving device may be initiated via a streaming transmission medium and transmission of the sponsored item to the receiving device may be initiated (314). For example, the audio story delivery manager 144 may initiate transmission of a recorded audio story associated with the selection 138 to a receiving device (e.g., the receiving device 120) via a streaming transmission medium and initiate transmission of the sponsored item 140 to the receiving device 120, as discussed above.

According to an example embodiment, the user profile may be associated with at least one of a registered subscriber user or a non-subscriber user. The user profile associated with the non-subscriber user may include an indication of a user preference of at least one of permission denial of storage of the user profile associated with the non-subscriber user in the user profile repository or permission denial of sharing of user attributes associated with the non-subscriber user (316).

According to an example embodiment, the sponsored item may be determined based on matching characteristics associated with at least two of the user profile, the story attribute information associated with the selected one of the recorded audio stories, and the current event. The current event may include at least one of a time of day, a local event, a national event, a global event, a weather event, a sporting event, a movie event, a product introduction event, a religious event, a historical event, a date, or an artistic event (318). For example, the sponsored item matching engine 162 may determine the sponsored item 140 based on matching characteristics associated with at least two of the user profile 136, the story attribute information 108 associated with the selected one of the recorded audio stories 138, and the current event 142, as discussed above

According to an example embodiment, transmission of the sponsored item to the receiving device may be initiated based on at least one of initiating transmission of a recorded audio clip associated with the sponsored item based on a streaming transmission via the streaming transmission medium to the receiving device, or initiating transmission of visual image data associated with the sponsored item to the receiving device (320). For example, the audio story delivery manager 144 may initiate transmission of the sponsored item 140 to the receiving device 120 based on at least one of initiating transmission of a recorded audio clip associated with the sponsored item 140, based on a streaming transmission via the streaming transmission medium to the receiving device 120, or initiate transmission of visual image data associated with the sponsored item 140 to the receiving device 120, as discussed above.

According to an example embodiment, behavioral indicators associated with a behavior of the user may be received, and update of one of the user profiles associated with the user may be initiated based on the received behavioral indicators. For example, the audio story request manager 130 may receive behavioral indicators associated with a behavior of the user 118 and initiate update of one of the user profiles 136 associated with the user 118 based on the received behavioral indicators, as discussed above.

According to an example embodiment, a recommendation list of suggested ones of the plurality of recorded audio stories may be obtained, based on at least one of the request, the user profile, a location associated with the user, a location associated with the receiving device, a weather condition indicator, an indicator of a time of day, a date indicator, a history of selections associated with a plurality of other users, or current events indicators. For example, the audio story selection engine 134 may obtain the recommendation list 166 of suggested ones of the plurality of recorded audio stories, as discussed above. According to an example embodiment, transmission of the recommendation list to the receiving device may be initiated. For example, the audio story delivery manager 144 may initiate transmission of the recommendation list 166 to the receiving device 120, as discussed above.

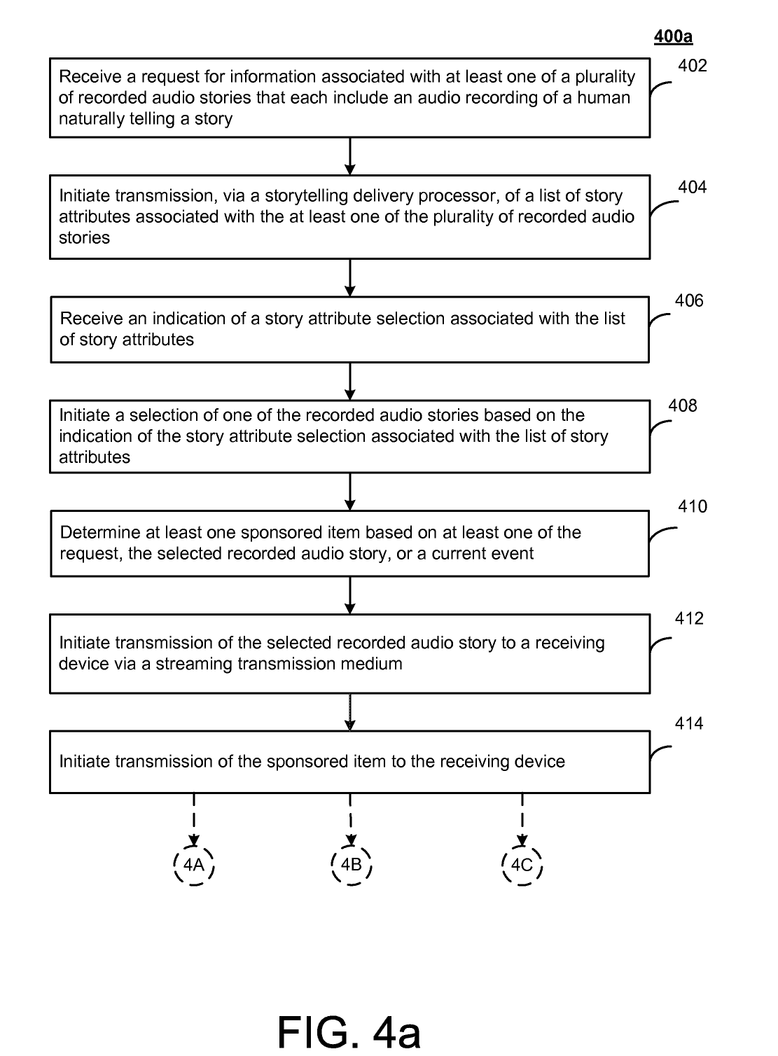

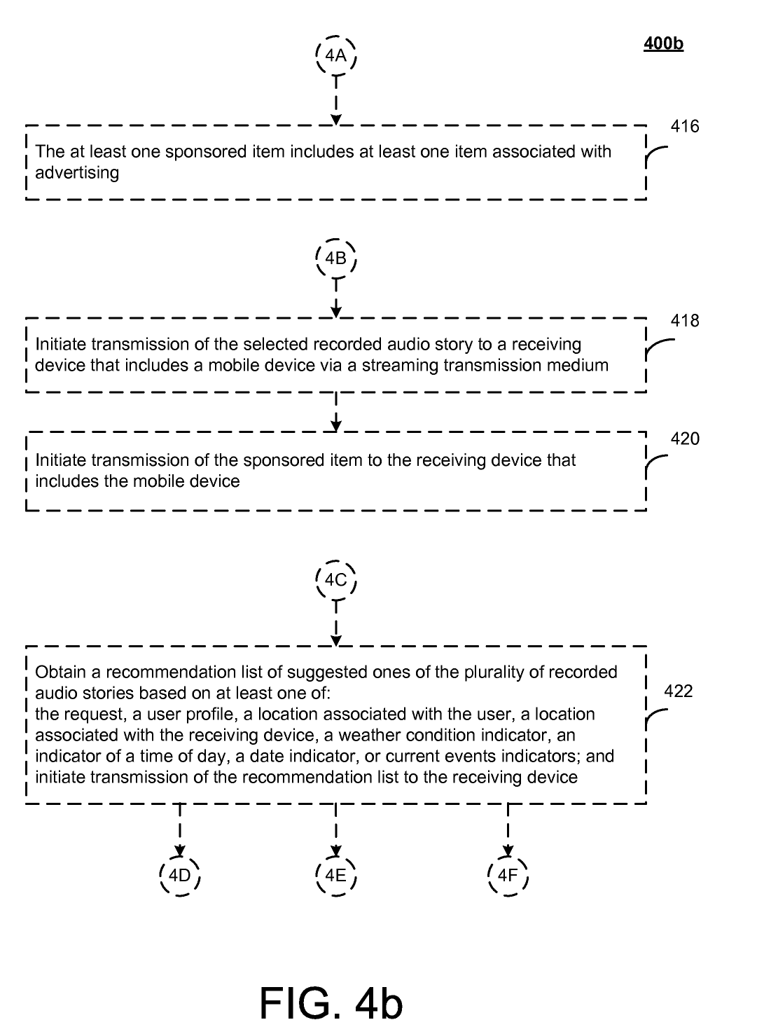

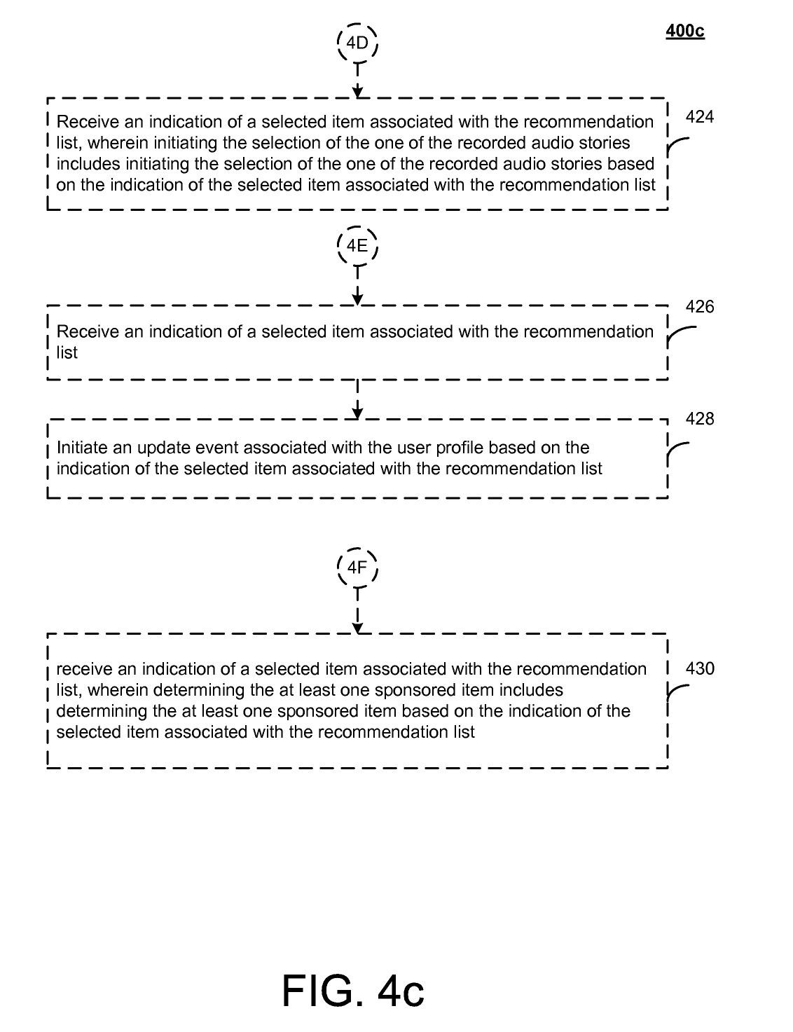

FIGS. 4a-4c are a flowchart illustrating example operations of the system of FIG. 1, according to example embodiments. In the example of FIG. 4a, a request for information associated with at least one of a plurality of recorded audio stories that each include an audio recording of a human naturally telling a story may be received (402). For example, the audio story request manager 130 may receive the user request 132, as discussed above.

Transmission of a list of story attributes associated with the at least one of the plurality of recorded audio stories may be initiated, via a storytelling delivery processor (404). For example, the audio story delivery manager 144 may initiate transmission of the recommendation list 166, as discussed above.

An indication of a story attribute selection associated with the list of story attributes may be received (406). For example, the audio story request manager 130 may receive the indication of the story attribute selection 138, as discussed above.

A selection of one of the recorded audio stories may be initiated based on the indication of the story attribute selection associated with the list of story attributes (408). For example, the audio story selection engine 134 may initiate the selection, as discussed above.

At least one sponsored item may be determined based on at least one of the request, the selected recorded audio story, or a current event (410). For example, the matching engine 164 may determine the at least one sponsored item 140, as discussed above.

Transmission of the selected recorded audio story to a receiving device may be initiated via a streaming transmission medium (412). Transmission of the sponsored item to the receiving device may be initiated (414). For example, the audio story delivery manager 144 may initiate transmission of the selected recorded audio story and the sponsored item 140 to the receiving device 120, as discussed above.

According to an example embodiment, the at least one sponsored item may include at least one item associated with advertising (416). According to an example embodiment, transmission of the selected recorded audio story to a receiving device that includes a mobile device may be initiated via a streaming transmission medium (418). According to an example embodiment, transmission of the sponsored item to the receiving device that includes the mobile device may be initiated (420).

According to an example embodiment, a recommendation list of suggested ones of the plurality of recorded audio stories may be obtained based on at least one of the request, a user profile, a location associated with the user, a location associated with the receiving device, a weather condition indicator, an indicator of a time of day, a date indicator, or current events indicators (422). For example, the audio story selection engine 134 may obtain the recommendation list 166, as discussed above.

According to an example embodiment, an indication of a selected item associated with the recommendation list may be received, wherein initiating the selection of the one of the recorded audio stories may include initiating the selection of the one of the recorded audio stories based on the indication of the selected item associated with the recommendation list (424). For example, the audio story request manager 130 may receive the indication of the selected item 138 associated with the recommendation list 166, as discussed above.

According to an example embodiment, an indication of a selected item associated with the recommendation list may be received (426). According to an example embodiment, an update event associated with the user profile may be initiated based on the indication of the selected item associated with the recommendation list (428). For example, the audio story request manager 130 may initiate update of one of the user profiles 136, as discussed above.

According to an example embodiment, an indication of a selected item associated with the recommendation list may be received, wherein determining the at least one sponsored item may include determining the at least one sponsored item based on the indication of the selected item associated with the recommendation list (430). For example, the matching engine 164 may determine the at least one sponsored item 140, as discussed above.

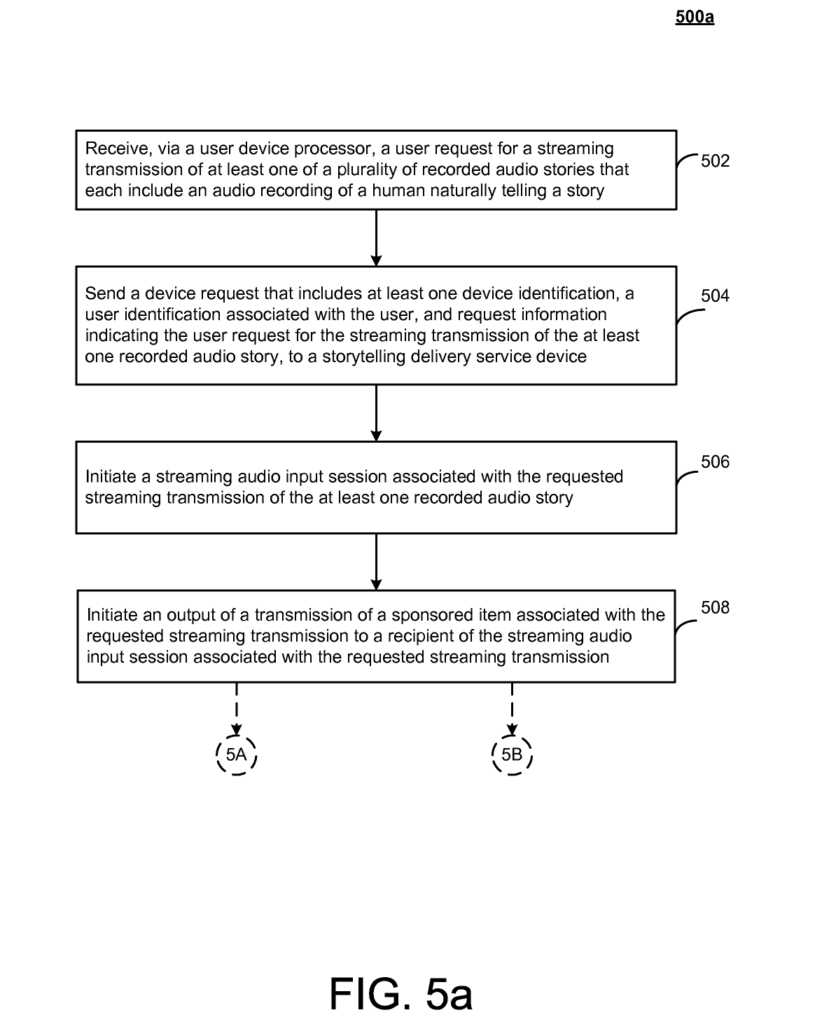

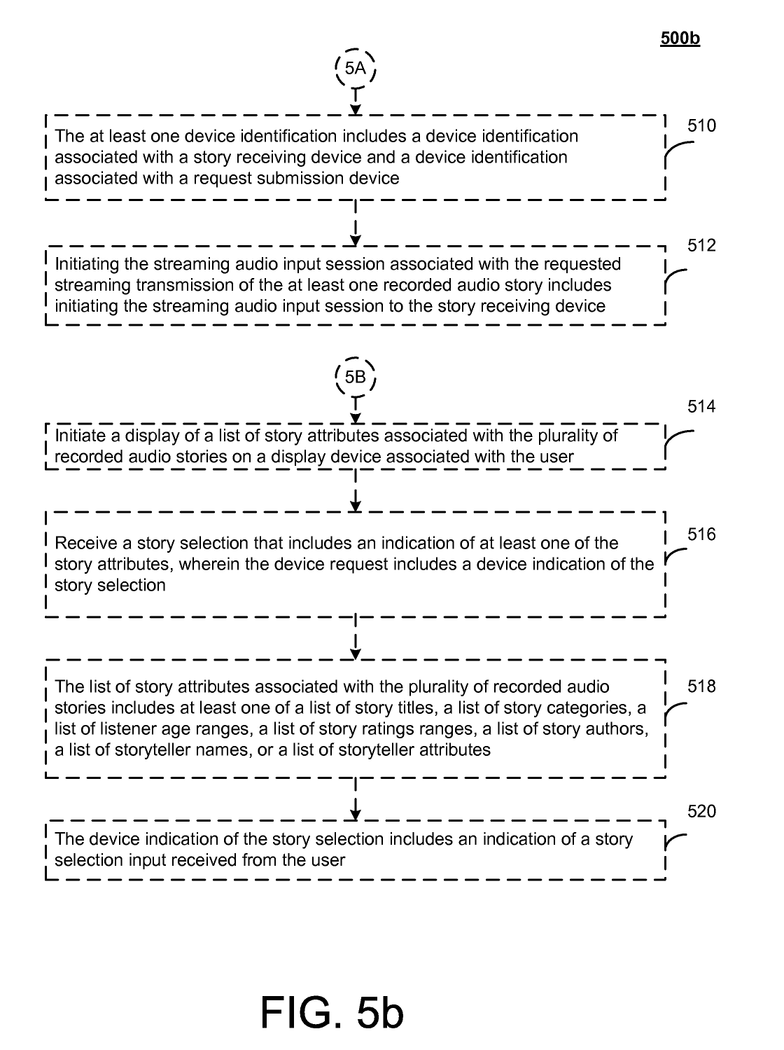

FIGS. 5a-5b are a flowchart illustrating example operations of the system of FIG. 2, according to example embodiments. In the example of FIG. 5a, a user request for a streaming transmission of at least one of a plurality of recorded audio stories that each include an audio recording of a human naturally telling a story may be received, via a user device processor (502). For example, the user request receiving engine 204 may receive, via the user device processor 206, the user request 208 for a streaming transmission of at least one of a plurality of recorded audio stories that each include an audio recording of a human naturally telling a story, as discussed above.

A device request that includes at least one device identification, a user identification associated with the user, and request information indicating the user request for the streaming transmission of the at least one recorded audio story, may be sent to a storytelling delivery service device (504). For example, the device request transmission engine 214 may send the device request 216 to the storytelling delivery service device, as discussed above.

A streaming audio input session associated with the requested streaming transmission of the at least one recorded audio story may be initiated (506). For example, the audio input interface engine 218 may initiate the streaming audio input session associated with the requested streaming transmission of the at least one recorded audio story, as discussed above.

An output of a transmission of a sponsored item associated with the requested streaming transmission to a recipient of the streaming audio input session associated with the requested streaming transmission may be initiated (508). For example, the sponsored item receiving engine 220 may initiate the output of the transmission of the sponsored item 222 associated with the requested streaming transmission to the recipient of the streaming audio input session associated with the requested streaming transmission, as discussed above.

According to an example embodiment, the at least one device identification may include a device identification associated with a story receiving device and a device identification associated with a request submission device (510).

According to an example embodiment, initiating the streaming audio input session associated with the requested streaming transmission of the at least one recorded audio story may include initiating the streaming audio input session to the story receiving device (512). According to an example embodiment, a display of a list of story attributes associated with the plurality of recorded audio stories may be initiated on a display device associated with the user (514). For example, the listing interface engine 224 may initiate the display of the list of story attributes 226 associated with the plurality of recorded audio stories on the display device 122 associated with the user 118, as discussed above.

According to an example embodiment, a story selection that includes an indication of at least one of the story attributes may be received, wherein the device request may include a device indication of the story selection (516). For example, the story selection interface engine 228 may receive the story selection 230 that includes an indication of at least one of the story attributes, wherein the device request 216 may include the device indication of the story selection 230, as discussed above.

According to an example embodiment, the list of story attributes associated with the plurality of recorded audio stories may include at least one of a list of story titles, a list of story categories, a list of listener age ranges, a list of story ratings ranges, a list of story authors, a list of storyteller names, or a list of storyteller attributes (518). According to an example embodiment, the device indication of the story selection may include an indication of a story selection input received from the user (520).

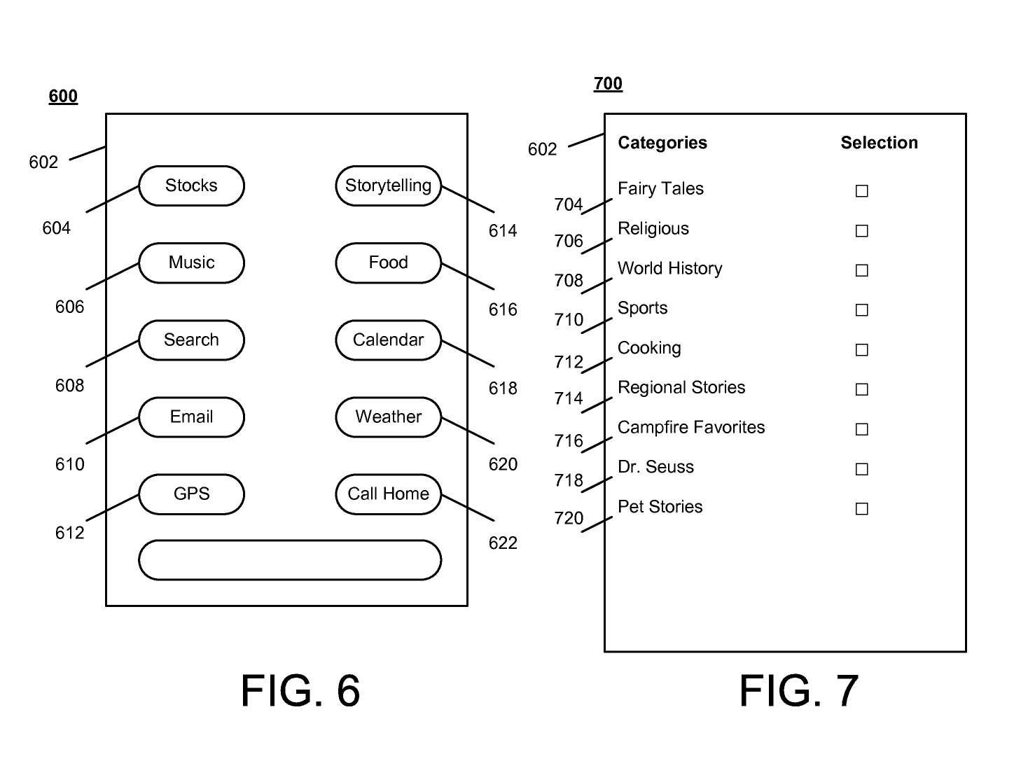

FIG. 6 depicts an example user view of a graphical display of an example selection display on a device. As shown in FIG. 6, a display 602 indicates a listing of device applications that are provided for selection by a user. As shown in FIG. 6, buttons indicate selection candidates including “Stocks” 604, “Music” 606, “Search” 608, “Email” 610, “GPS” 612, “Storytelling” 614, “Food” 616, “Calendar” 618, “Weather” 620, and “Call Home” 622. For example, the user 118 may view the display 602 on the display device 122, as discussed above. As shown in FIG. 6, the user 118 may select the button “Storytelling” 614 to activate a storytelling application such as the device application discussed above with regard to FIG. 2.

FIG. 7 depicts an example user view of a graphical display of an example selection display on a device. As shown in FIG. 7, the display 602 (e.g., via the display device 122) indicates a listing of story categories that are provided for selection by a user. As shown in FIG. 7, check boxes are provided for indicating selection candidates including “Fairy Tales” 704, “Religious” 706, “World History” 708, “Sports” 710, “Cooking” 712, “Regional Stories” 714, “Campfire Favorites” 716, “Dr. Seuss” 718, and “Pet Stories” 720. As shown in FIG. 7, the user 118 may select “Fairy Tales” 704 to activate a request for a listing of fairy tales that may be available from the storytelling delivery service.

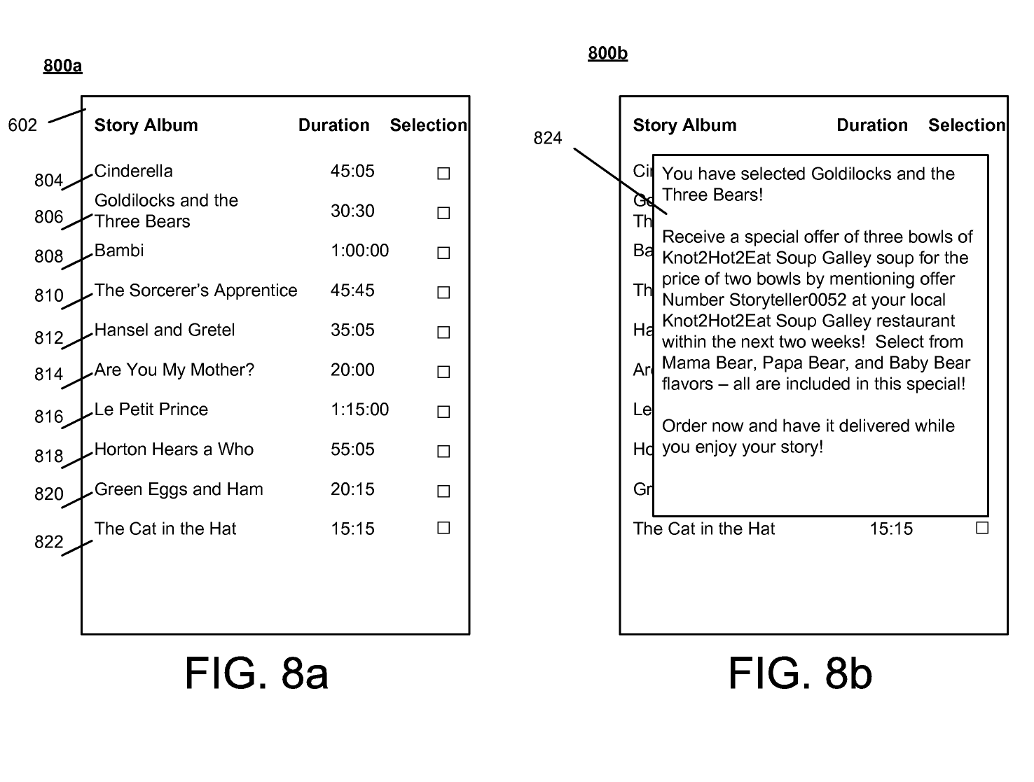

FIG. 8a depicts an example user view of a graphical display of an example selection display on a device. As shown in FIG. 8, the display 602 (e.g., via the display device 122) indicates a listing of story titles that are provided for selection by a user. As shown in FIG. 8, duration indicators and check boxes are provided for indicating selection candidates including “Cinderella” 804, “Goldilocks and the Three Bears” 806, “Bambi” 808, “The Sorcerer's Apprentice” 810, “Hansel and Gretel” 812, “Are You My Mother?” 814, “Le Petit Prince” 816, “Horton Hears a Who” 818, “Green Eggs and Ham” 820, and “The Cat in the Hat” 822. As shown in FIG. 8, the user 118 may select “Goldilocks and the Three Bears” 806 to activate a request for a streaming transmission of a recorded audio story version of the Goldilocks fairy tale that may be available via the storytelling delivery service. For example, the user request 132 may be sent to the storytelling delivery engine 102 with a selection 138 indicating the Goldilocks fairy tale as a requested recorded audio story.

FIG. 8b depicts an example user view of a graphical display of a sponsored item visual image display on a device. As shown in FIG. 8b, the display 602 (e.g., via the display device 122) indicates a popup advertisement 824 indicating a discount offer for soup purchases from local restaurants. For example, the sponsored item 140 may be transmitted and displayed as the story transmission to the audio output device 124 is begun, or at various points such as pause periods during the transmission session, as discussed above. For example, the sponsored item 140 may also be transmitted as audio data to an audio output device, as discussed above.

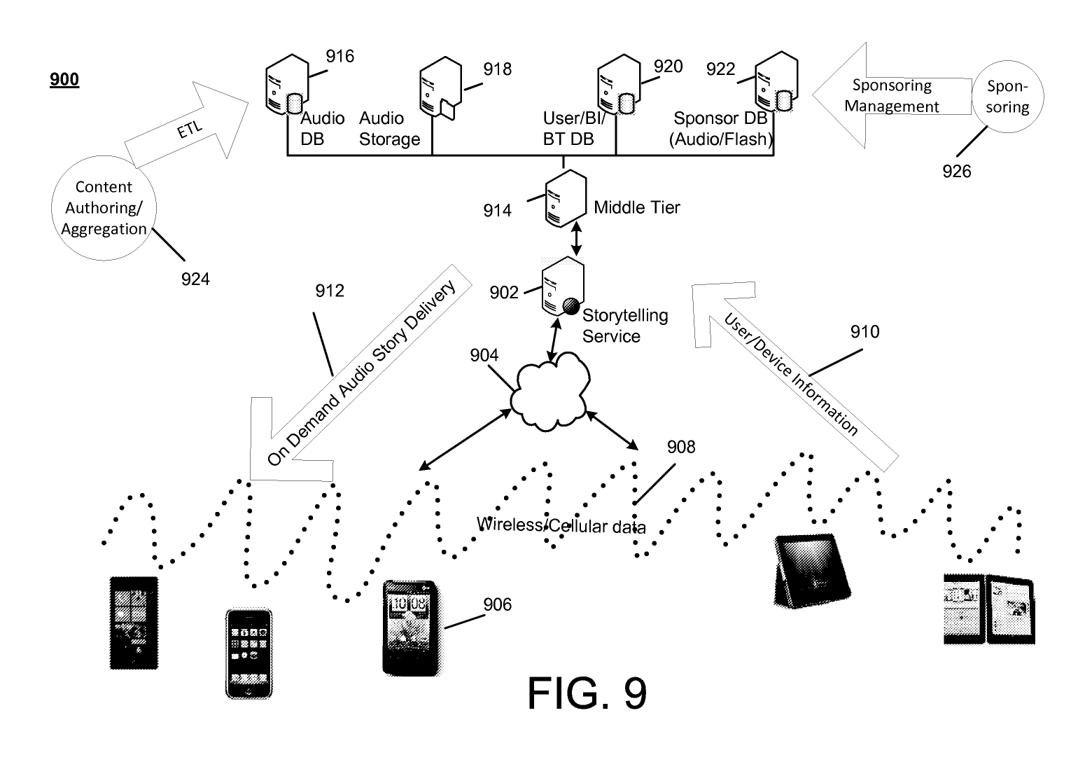

FIG. 9 is a block diagram of an example system for storytelling delivery based on request. As shown in FIG. 9, a storytelling service 902 (e.g., based on the storytelling delivery engine 102) may be in communication with a network 904 (e.g., the network 128) that is in communication with devices such as the mobile device 906 (e.g., the receiving device 120), based on wireless cellular data 908 transmitted over the network 904. As shown in FIG. 9, user device information 910 may be sent from the user devices to the storytelling service 902, and on demand story delivery 912 may be transmitted to the user devices (e.g., via a streaming transmission session).

The storytelling service 902 may further communicate with at least one middle tier device 914, for example, a server configured to manage communications between the storytelling service device 902 and one or more storage devices. The storage devices may include an audio database device 916, an audio storage device 918, a user business intelligence/behavioral targeting (BI/BT) database device 920, and a sponsor database 922.

The audio database device 916 (e.g., the audio story repository 112) may store the story attribute information 108 associated with the plurality of recorded audio stories. A content authoring/aggregation event 924 may include actions, for example, by a system administrator in collecting recorded audio stories for inclusion in the audio database storage device 916 and the audio storage device 918 (e.g., the audio data repository 110). For example, the user administrator may purchase licenses for recorded audio stories from owners of the works, and may obtain the recorded audio stories from other sources such as via downloads from the Internet. For example, recorded audio stories may be obtained via extract, transform and load (ETL) operations, for extracting data from outside sources.

The user business intelligence/behavioral targeting (BI/BT) database device 920 may store information such as types of user or system behaviors that may be used for determining story recommendation lists and for determining a type of sponsored item for sending to users with the recorded audio stories. For example, the sponsor database 922 may store the sponsored items 140 and the sponsored item information 152, similarly to the sponsored item repository 148 discussed above with regard to FIG. 1. A sponsoring event 926 may depict a user administrator managing the sponsor database 922 based on administrator interaction with potential sponsors for providing content for the sponsor database 922. For example, the sponsors may include manufacturers of products, managers of stores and restaurants, and service provider managers.

Customer privacy and confidentiality have been ongoing considerations in online environments for many years. Thus, a storytelling delivery service may provide customer information regarding risks associated with the customer providing personal information for use in association with a customer profile. The storytelling delivery service may offer options for a potential customer to use the service on individual one-time sessions in lieu of a subscription in which the customer information may be persistently stored for retrieval upon subsequent requests for story transmission. The storytelling delivery service may also request permission from potential customers before sharing customer information with sponsors such as companies providing advertising. The storytelling delivery service may inform a potential customer that he/she may receive a story transmission, and that the customer may decline to provide personal information other than an online address (i.e., as a target for transmitting the story) and any other optional information that the customer may elect to provide (e.g., a gender, an age range, an income range, an ethnicity, personal preferences permission), for use in updating suggestions of stories and sponsors for all users of the service.

The storytelling delivery service may request an email address for sending an email to confirm permission before customer personal information is entered into the system, to ensure that the customer is informed of potential risks of electronically stored personal/private information. Further, authentication techniques may be included in order for the customer to continue to use the storytelling delivery service. For example, a user identifier and password may be requested for future access to the system. As another example, an authorized fingerprint or audio identification (e.g., via voice recognition) may be requested for the access. Additionally, access to networked elements of the system may be provided via secured connections (or hardwired connections), and firewalls may be provided to minimize risk of potential hacking into the system.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine usable or machine readable storage device (e.g., a magnetic or digital medium such as a Universal Serial Bus (USB) storage device, a tape, hard disk drive, compact disk, digital video disk (DVD), etc.) or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand alone program or as a module, component, subroutine, or other unit suitable for use in a computing environment. A computer program that might implement the techniques discussed above may be deployed to be executed on one computer or on multiple computers at one site or distributed across multiple sites and interconnected by a communication network.

Method steps may be performed by one or more programmable processors executing a computer program to perform functions by operating on input data and generating output. The one or more programmable processors may execute instructions in parallel, and/or may be arranged in a distributed configuration for distributed processing. Method steps also may be performed by, and an apparatus may be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back end component, e.g., as a data server, or that includes a middleware component, e.g., an application server, or that includes a front end component, e.g., a client computer having a graphical user interface or a Web browser through which a user can interact with an implementation, or any combination of such back end, middleware, or front end components. Components may be interconnected by any form or medium of digital data communication, e.g., a communication network. Examples of communication networks include a local area network (LAN) and a wide area network (WAN), e.g., the Internet.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A system comprising:
a storytelling delivery engine that includes:
a story database interface engine configured to obtain, via a storytelling delivery processor, story attribute information associated with a plurality of recorded audio stories that each include an audio recording of a human naturally telling a story;
an audio story request manager configured to receive a request associated with a user of an audio story delivery service;
an audio story selection engine configured to
access at least one user profile associated with the request,
obtain a selection of one of the recorded audio stories based on information included in the user profile and the request,
access the story attribute information that is associated with the selected one of the recorded audio stories via the story database interface engine, and
obtain at least one sponsored item based on at least one of the request, the user profile, the story attribute information associated with the selected one of the recorded audio stories, or a current event; and
an audio story delivery manager configured to initiate transmission of a recorded audio story associated with the selection to a receiving device via a streaming transmission medium and initiate transmission of the sponsored item to the receiving device.

2. The system of claim 1, further comprising:
a sponsored item database interface engine configured to access sponsored item information, wherein
the audio story selection engine is configured to obtain the at least one sponsored item via the sponsored item database interface engine; and
a user profile database interface engine configured to access at least one user profile associated with at least one user of the audio story delivery service, wherein
the audio story selection engine is configured to access the at least one user profile associated with the request via the user profile database interface engine.

3. The system of claim 1, further comprising:
an audio database interface engine configured to access audio information associated with the recorded audio stories, wherein
the audio story delivery manager is configured to initiate transmission of the recorded audio story associated with the selection to the receiving device via the audio database interface engine.

4. The system of claim 1, wherein:
the user profile is associated with at least one of
a registered subscriber user, or
a non-subscriber user, wherein
the user profile associated with the non-subscriber user includes an indication of a user preference of at least one of permission denial of storage of the user profile associated with the non-subscriber user in a user profile repository or permission denial of sharing of user attributes associated with the non-subscriber user.

5. The system of claim 1, further comprising:
a sponsored item matching engine configured to determine the sponsored item based on matching characteristics associated with at least two of:
the user profile, the story attribute information associated with the selected one of the recorded audio stories, and the current event, wherein
the current event includes at least one of a time of day, a local event, a national event, a global event, a weather event, a sporting event, a movie event, a product introduction event, a religious event, a historical event, a date, or an artistic event.

6. The system of claim 1, wherein:
the audio story request manager is configured to receive behavioral indicators associated with a behavior of the user and initiate update of one of the user profiles associated with the user based on the received behavioral indicators,
the audio story selection engine is configured to obtain a recommendation list of suggested ones of the plurality of recorded audio stories based on at least one of the request, the user profile, a location associated with the user, a location associated with the receiving device, a weather condition indicator, an indicator of a time of day, a date indicator, a history of selections associated with a plurality of other users, or current events indicators, and
the audio story delivery manager is configured to initiate transmission of the recommendation list to the receiving device.

7. The system of claim 1, wherein:
the audio story delivery manager is configured to initiate transmission of the sponsored item to the receiving device based on at least one of:
initiating transmission of a recorded audio clip associated with the sponsored item based on a streaming transmission via the streaming transmission medium to the receiving device, or
initiating transmission of visual image data associated with the sponsored item to the receiving device.

8. The system of claim 1, wherein:
at least one of the user profiles includes historical information associated with a history of selections of the recorded audio stories associated with one of the users associated with the at least one of the user profiles.

9. The system of claim 1, wherein:
at least one of the user profiles includes user information received from one of the users associated with the at least one of the user profiles, including at least one of an indicator associated with an age, an indicator associated with a preference of a category of stories, an indicator associated with a preference of a type of receiving device, an indicator associated with a preference of a natural language, an indicator associated with an album of favorite stories, an indicator of a user preference for at least one of the recorded audio stories, an indicator associated with a preference of a category of sponsored items, or an indication of a permission type associated with the at least one of the user profiles.

10. A computer program product tangibly embodied on a computer-readable medium and including executable code that, when executed, is configured to cause at least one data processing apparatus to:
receive a request for information associated with at least one of a plurality of recorded audio stories that each include an audio recording of a human naturally telling a story;
initiate transmission, via a storytelling delivery processor, of a list of story attributes associated with the at least one of the plurality of recorded audio stories;
receive an indication of a story attribute selection associated with the list of story attributes;
initiate a selection of one of the recorded audio stories based on the indication of the story attribute selection associated with the list of story attributes;
determine at least one sponsored item based on at least one of the request, the selected recorded audio story, or a current event;
initiate transmission of the selected recorded audio story to a receiving device via a streaming transmission medium; and
initiate transmission of the sponsored item to the receiving device.

11. The computer program product of claim 10, wherein the executable code, when executed, is configured to cause the at least one data processing apparatus to:
obtain a recommendation list of suggested ones of the plurality of recorded audio stories based on at least one of:
the request, a user profile, a location associated with the user, a location associated with the receiving device, a weather condition indicator, an indicator of a time of day, a date indicator, or current events indicators; and initiate transmission of the recommendation list to the receiving device.

12. The computer program product of claim 11, wherein the executable code, when executed, is configured to cause the at least one data processing apparatus to:
receive an indication of a selected item associated with the recommendation list, wherein
initiating the selection of the one of the recorded audio stories includes initiating the selection of the one of the recorded audio stories based on the indication of the selected item associated with the recommendation list.

13. The computer program product of claim 11, wherein the executable code, when executed, is configured to cause the at least one data processing apparatus to:
receive an indication of a selected item associated with the recommendation list; and
initiate an update event associated with the user profile based on the indication of the selected item associated with the recommendation list.

14. The computer program product of claim 11, wherein the executable code, when executed, is configured to cause the at least one data processing apparatus to:
receive an indication of a selected item associated with the recommendation list, wherein
determining the at least one sponsored item includes determining the at least one sponsored item based on the indication of the selected item associated with the recommendation list.

15. The computer program product of claim 10, wherein:
the at least one sponsored item includes at least one item associated with advertising.

16. The computer program product of claim 10, wherein the executable code, when executed, is configured to cause the at least one data processing apparatus to:
initiate transmission of the selected recorded audio story to a receiving device that includes a mobile device via a streaming transmission medium; and
initiate transmission of the sponsored item to the receiving device that includes the mobile device.

17. A computer program product tangibly embodied on a computer-readable medium and including executable code that, when executed, is configured to cause at least one data processing apparatus to:
receive, via a user device processor, a user request for a streaming transmission of at least one of a plurality of recorded audio stories that each include an audio recording of a human naturally telling a story;
send a device request that includes at least one device identification, a user identification associated with the user, and request information indicating the user request for the streaming transmission of the at least one recorded audio story, to a storytelling delivery service device;
initiate a streaming audio input session associated with the requested streaming transmission of the at least one recorded audio story; and
initiate an output of a transmission of a sponsored item associated with the requested streaming transmission to a recipient of the streaming audio input session associated with the requested streaming transmission.

18. The computer program product of claim 17, wherein the executable code, when executed, is configured to cause the at least one data processing apparatus to:
initiate a display of a list of story attributes associated with the plurality of recorded audio stories on a display device associated with the user; and
receive a story selection that includes an indication of at least one of the story attributes,
wherein the device request includes a device indication of the story selection.

19. The computer program product of claim 18, wherein:
the list of story attributes associated with the plurality of recorded audio stories includes at least one of:
a list of story titles, a list of story categories, a list of listener age ranges, a list of story ratings ranges, a list of story authors, a list of storyteller names, or a list of storyteller attributes; and
the device indication of the story selection includes an indication of a story selection input received from the user.

20. The computer program product of claim 17, wherein:
the at least one device identification includes a device identification associated with a story receiving device and a device identification associated with a request submission device; and
initiating the streaming audio input session associated with the requested streaming transmission of the at least one recorded audio story includes initiating the streaming audio input session to the story receiving device.
